(19) United States
(12) Patent Application Publication
(10) Pub. No.: US 2018/0201826 A1
(43) Pub. Date: Jul. 19, 2018

(54) SYNERGISTIC CORROSION INHIBITORS

(71) Applicant: Baker Hughes, a GE Company, LLC, Houston, TX (US)

(72) Inventors: Zhengwei Liu, Houston, TX (US); Tracey S. Jackson, Sugar Land, TX (US); Sunder Ramachandran, Sugar Land, TX (US)

(73) Assignee: Baker Hughes, a GE Company, LLC, Houston, TX (US)

(21) Appl. No.: 15/872,416

(22) Filed: Jan. 16, 2018

Related U.S. Application Data
(60) Provisional application No. 62/447,116, filed on Jan. 17, 2017.

(51) Int. Cl. C09K 8/54; C10G 75/02; F17D 3/12; F17D 5/00; E21B 37/06

(52) U.S. Cl. CPC C09K 8/54; C10G 75/02; C09K 2208/32; F17D 5/00; E21B 37/06; F17D 3/12

(57) ABSTRACT

A corrosion inhibitor additive is circulated in a system with a corrosion environment to inhibit metal corrosion. The corrosion inhibitor additive includes a first component and a second component. The second component includes without limitation, imidazolines, amides, quaternary amines, carboxylic acid reaction products, organophosphates, phenathradine derivatives, heterocyclic molecules containing one or both of nitrogen and sulfur, and combinations thereof. The first component may have one of the following formulas:

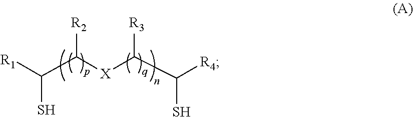

wherein x is oxygen or hydrogenated nitrogen or quaternized nitrogen; R₁, R₂, R₃ and R₄ are independently hydrogen, methyl or an alkyl group; p, q and n are independently integers from 1 to 100; and

SH—CH₂—[CH₂—O—CH₂]_{z}—CH₂—SH (A1)

where z is an integer ranging from 1 to 100; and where a lower amount of the corrosion inhibitor additive is used to achieve the same or better results in inhibiting the corrosion of the metal surface as compared to an otherwise identical method for inhibiting corrosion absent the corrosion inhibitor additive.

### CROSS-REFERENCE TO RELATED APPLICATION

This application claims the benefit of U.S. Provisional Patent Application Ser. No. 62/447,116 filed Jan. 17, 2017, which is incorporated herein by reference in its entirety.

### TECHNICAL FIELD

The present invention relates to inhibiting the corrosion rate of a mild steel surface by incorporating a synergistic corrosion inhibitor additive in a corrosive environment having a metal surface in oil and gas production technologies or processes. This invention may be used in wells and pipelines that produce oil and gas. It also may be used in transportation pipelines and refinery applications.

### BACKGROUND

It is widely known that metal surfaces, such as ferrous and non-ferrous and respective alloys, are subject to corrosion under certain circumstances. As used herein, ferrous metals include, in some non-limiting embodiments, iron and steel. Corrosion is generally defined as any deterioration of essential properties in a material due to chemical interaction with its environment, and in most situations it is considered to be undesirable. The result of corrosion is usually formation of an oxide and/or a salt of the original metal. In most cases corrosion comprises the dissolution of a material. It may also be caused by exposure to corrosive chemicals, including, for example, acids, bases, dehydrating agents, halogens and halogen salts, organic halides and organic acid halides, acid anhydrides, and some organic materials such as phenol.

To combat corrosion, any susceptible metal may be treated, contacted, and/or surrounded with a corrosion inhibitor. Susceptible metal surfaces may be those having a thermodynamic profile relatively favorable to corrosion. Because the efficacy of any particular corrosion inhibitor is generally known to be dependent upon the circumstances under which it is used, a wide variety of corrosion inhibitors have been developed and targeted for use. One target of great economic interest is the treatment of crude oil and gas systems, for protecting the variety of metal surfaces, e.g. ferrous, non-ferrous, or otherwise, needed for obtaining and processing the oils and gases. Oil and gas systems are defined as including metal equipment in a subterranean formation as well as on the surface, including piping, tubing, tools and other metal surfaces, along with those leading to and in a petroleum refinery. Such metal surfaces are present in oil and gas wells, including, for example, production and gathering pipelines, where the metal surfaces may be exposed to a variety of acids, acid gases, such as CO₂ and H₂S, bases, and brines of various salinities. Other applications include industrial water treatments, construction materials, coatings, and the like. In some cases, the corrosion inhibitors are desirably tailored for inhibiting specific types of corrosion, and/or for use under particular conditions of temperature, pressure, shear, and the like, and/or for inhibiting corrosion on a generalized or localized basis.

A number of corrosion inhibitors featuring sulfur-containing compounds have been described. For example, U.S. Pat. No. 5,863,415 discloses thiophosphorus compounds of a specific formula to be particularly useful for corrosion inhibition in hot liquid hydrocarbons and may be used at concentrations that add to the fluid less of the catalyst-impairing phosphorus than some other phosphorus-based corrosion inhibitors. These thiophosphorus compounds also offer the advantage of being able to be prepared from relatively low cost starting materials.

Other sulfur-containing compounds are disclosed in, for example, U.S. Pat. No. 5,779,938, which describes corrosion inhibitors that are reaction products of one or more tertiary amines and certain carboxylic acids, preferably a mixture of mercaptocarboxylic and carboxylic acids. The use of sulphydryl acid and imidazoline salts is disclosed as inhibitors of carbon corrosion of iron and ferrous metals in WO 98/41673. Corrosion of iron is also addressed in WO 99/39025, which describes using allegedly synergistic compositions of polymethylene-polyaminodipropion-amides associated with mercaptoacids. A number of specific sulfur-containing compounds are currently in commercial use as corrosion inhibitors for certain types of systems.

Such corrosion inhibitors may not be satisfactory in reducing corrosion when applied in low amounts. Thus, it is desirable to have methods and/or corrosion inhibitors that can inhibit corrosion of metal surfaces within a subterranean formation during a downhole operation, as well as in other contexts, more cost effectively and with less environmental impact.

### SUMMARY

There is provided, in one form, a method for inhibiting corrosion of a metal surface in a corrosive environment using a synergistic corrosion inhibitor additive having two components where less corrosion of the metal surface occurs as compared to an otherwise identical method absent the corrosion inhibitor additive. The method may include incorporating such a corrosion inhibitor additive into a corrosive environment, including but not necessarily limited to within an oil and gas production system.

In an exemplary embodiment, the first component of the corrosion inhibitor additive may be represented by the following general formula, Formula A:

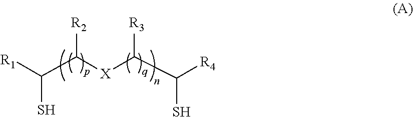

wherein x is oxygen or hydrogenated nitrogen or quaternized nitrogen; R₁, R₂, R₃ and R₄ are independently hydrogen, methyl or an alkyl group; n, p and q are independently integers from 1 to 100. In one non-limiting embodiment, Formula A1, where n is 2, shown below, may be included in the corrosion inhibitor additive as the first component.

SH—CH₂—[CH₂—O—CH₂]₂—CH₂—SH (A1)

The second component of the corrosion inhibitor additive may be 1) imidazolines and amides, such as the reaction products of fatty acids and amines (di-amines, tri-amines, or di-amines and tri-amines that are alcohol or thiol substituted), 2) quaternary amines, such as bis-quaternary amines, 3) carboxylic acid reaction products including maleic derivatives reacted with unsaturated alkyl carboxylic acids, and dimerized or trimerized acids including unsaturated alkyl groups, 4) organophosphates, especially ethoxylated organophosphate esters, 5) phenathradine derivatives and 6) heterocyclic molecules containing one or both of nitrogen and sulfur, and/or 7) combinations thereof.

It is provided that a corrosion inhibitor additive comprising these two components has a synergistic impact and reduces or inhibits corrosion of a metal surface using an amount of additive that is lower than amounts typically used to achieve the same results.

### BRIEF DESCRIPTION OF THE DRAWINGS

FIG. 1 is a graph comparing the inhibition efficiency of one example of an additive disclosed herein to the inhibition efficiency of the individual components of that additive, when introduced at the same amount/concentration.

FIG. 2 is a graph comparing the inhibition efficiency of a second example of an additive disclosed herein to the inhibition efficiency of the individual components of that additive, when introduced at the same amount/concentration.

FIG. 3 is a graph comparing the inhibition efficiency of a third example of an additive disclosed herein to the inhibition efficiency of the individual components of that additive, when introduced at the same amount/concentration.

### DETAILED DESCRIPTION

It has been discovered that corrosion of metal surfaces in high temperature environments may be more efficiently decreased, reduced, inhibited and/or prevented by introducing a corrosion inhibitor additive having two components into a corrosive environment. The corrosion inhibitor additive disclosed herein has a synergistic effect in reducing, decreasing, inhibiting, and/or preventing corrosion such that a lower amount of the corrosion inhibitor additive may be used to achieve the same or better results in reducing, decreasing, inhibiting, and/or preventing the corrosion of the metal surface as compared to an otherwise identical method absent the corrosion inhibitor additive disclosed herein, or alternatively as compared to an otherwise identical method using only the first component or only the second component at the same total dosage.

The corrosion inhibition additive disclosed herein may be used in various systems in which a corrosive environment may be found.

“System” is defined herein to be a subterranean system that includes a fluid and any components therein (e.g. pipes or conduits where the downhole fluid may flow through or alongside). In one non-limiting embodiment the system may be defined as any corrosive environment having a metal surface in physical contact with a production fluid. In a non-limiting example, if the system includes a packer fluid then the method applies to decreasing or inhibiting corrosion of any metal in contact with the packer fluid. The system may include a downhole fluid composition that may have or include an aqueous-based fluid, a non-aqueous-based fluid, corrosion forming components, and corrosion inhibitor additives. In a non-limiting embodiment, the downhole fluid may be circulated through a subterranean formation, such as a subterranean reservoir wellbore, during a downhole operation. The downhole operation may be or include, but is not limited to, a drilling operation, a completions operation, a stimulation operation, an injection operation, a servicing or remedial operation, and combinations thereof. In the instance the corrosion inhibitor additive is circulated into the subterranean reservoir wellbore at the same time as the downhole fluid, the corrosion inhibitor additive may be added to the downhole fluid prior to the circulation of the downhole fluid into the subterranean formation or wellbore.

A drilling operation is used to drill into a subterranean reservoir formation, and a drilling fluid accompanies the drilling operation. A completions operation is performed to complete a well, such as the steps and assembly of equipment (e.g. downhole tubulars) to bring a well into production once the drilling operations are done. A stimulation operation is one where a treatment is performed to restore or enhance the productivity of a well, such as hydraulic fracturing (above the fracture pressure of the reservoir formation) and matrix treatments (below the fracture pressure of the reservoir formation). An injection operation includes a well where fluids are injected into the well, instead of produced therefrom, to maintain reservoir pressure therein. A servicing operation allows for maintenance to the well during and/or after the well has been completed and/or produced, enhancing the well productivity, and/or monitoring the performance of the well or reservoir.

Each downhole operation has its own respective downhole fluid, e.g. drilling operations utilize drilling fluids. Downhole fluids are typically classified according to their base fluid. In aqueous based fluids, solid particles are suspended in a continuous phase consisting of water or brine. Oil can be emulsified in the water, which is the continuous phase. “Aqueous based fluid” is used herein to include fluids having an aqueous continuous phase where the aqueous continuous phase can be all water, brine, seawater, and combinations thereof; an oil-in-water emulsion, or an oil-in-brine emulsion; and combinations thereof. For example, brine-based fluids are aqueous based fluids, in which the aqueous component is brine. “Brine” is defined as a water-based fluid comprising salts that have been controllably added thereto. “Seawater” is similar to brine, but the salts in the seawater have been disposed therein by a natural process, e.g. ocean water is a type of seawater that formed in the absence of any man-made intervention.

Non-aqueous based fluids, also known as oil-based fluids, are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, a brine-in-non-aqueous emulsion, a seawater-in-non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

The corrosion inhibitor additive disclosed herein may also be used in offshore systems, including, but not limited to, decreasing or inhibiting corrosion to pipelines and/or wellhead structures.

The first component of the corrosion inhibitor additive may be represented by the following general formula, Formula A:

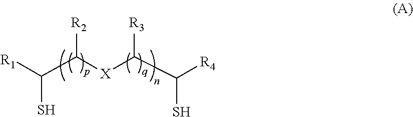

wherein x is oxygen or hydrogenated nitrogen or quaternized nitrogen; R₁, R₂, R₃ and R₄ are independently hydrogen, methyl or an alkyl group; n, p and q are independently integers from 1 to 100. In one non-limiting embodiment the alkyl group is defined as having from 1 independently to 100 carbon atoms; alternatively from 1 independently to 10 carbon atoms.

One specific form of Formula A is represented by Formula A1 wherein z is an integer ranging from 1 to 100.

SH—CH₂—[CH₂—O—CH₂]_{z}—CH₂—SH (A1)

The first component of the corrosion inhibitor additive may be 1,8,-dimercapto-3,6-dioxaoctane (DMDO), which is the case where in Formula A1 z is 2, and its derivatives. Suitable derivatives of DMDO include, but are not necessarily limited to, 2-Mercaptoethyl ether and Hexa(ethylene glycol) dithiol.

The second component that is combined with the first component to form the corrosion inhibitor additive may be one or more the following: 1) imidazolines and amides, such as the reaction products of fatty acids and amines (di-amines, tri-amines, or di-amines and tri-amines that are alcohol or thiol substituted), 2) quaternary amines, such as bis-quaternary amines, 3) carboxylic acid reaction products including maleic derivatives reacted with unsaturated alkyl carboxylic acids, and dimerized or trimerized acids including unsaturated alkyl groups, 4) organophosphates, especially ethoxylated organophosphate esters, 5) phenathradine derivatives and 6) heterocyclic molecules containing one or both of nitrogen and sulfur, and/or 7) combinations thereof.

Without wishing to be limited by temperature, the corrosion inhibitor additive can be used in high temperature environments. The temperature of the “high temperature” environment be above 150° F. (66° C.), may range from about 150° F. (66° C.) independently to about 500° F. (260° C.), alternatively from about 200° F. (93° C.) independently to about 450° F. (232° C.), or from about 300° F. (149° C.) independently to about 400° F. (204° C.). The corrosion inhibitor additive may be stable at a temperature ranging from about 150° F. (66° C.) independently to about 500° F. (260° C.), alternatively from about 250° F. (121° C.) independently to about 450° F. (232° C.), or from about 300° F. (149° C.) independently to about 400° F. (204° C.).

The additive may also prevent corrosion in environments at low temperatures from 35° F. (1.7° C.) to 150° F. (66° C.).

“Stable” as defined herein means the corrosion inhibitor additive may begin to decompose after a pre-determined amount of time, a change in temperature or pressure, etc. However, the corrosion inhibitor additive remains at least 60% functionally effective, alternatively 50% functionally effective, or about 30% functionally effective in another non-limiting embodiment. “Functionally effective” is defined to mean the ability of the corrosion inhibitor additive to reduce or inhibit corrosion of a metal surface in a high temperature environment, i.e. up to about 500° F. (260° C.).

The molar ratio of the first component to the second component within the corrosion inhibitor additive may range from about 1:2 independently to about 2:1, from about 1:10 independently to about 10:1, from about 1:100 independently to about 100:1, or from about 3:7 independently to about 7:3 in various embodiments. As used herein with respect to a range, “independently” means that any threshold may be used together with another threshold to give a suitable alternative range, e.g. molar ratio from about 1:100 independently to about 7:3 is also considered a suitable alternative range for the ratio of the corrosion inhibitor additive components.

It has been shown that the corrosion inhibitor additive containing the two components in ratios falling within these ranges have synergistic performance as compared to when the components are used individually (i.e. alone) as corrosion inhibitor additives in the same dosages. In another non-restrictive embodiment, a lower amount of the corrosion inhibitor additive is used to achieve the same or better results in inhibiting the corrosion of the metal surface as compared to an otherwise identical method using only the first component or only the second component at the same total dosage, i.e. where total amount of the corrosion inhibitor additive is the same as the amount of only the first component or the amount of only the second component.

This synergistic impact may be determined by measuring the inhibition efficiency of the components used alone or in combination with one another in equal dosages.

Inhibition efficiency may be calculated using the following formula:

$$Inhibition Efficiency = \frac{Uninhibited Corrosion Rate - Inhibited Corrosion Rate}{Uninhibited Corrosion Rate}$$

The effective amount of the corrosion inhibitor additive may range from about 0.01 ppmv independently to about 1,000 ppmv based on the amount of total produced fluids, alternatively from about 10 ppmv independently to about 1,000 ppmv, or from about 100 ppmv independently to about 500 ppmv.

In a non-limiting embodiment, the fluid may include dissolved solids or salt species which can provide conductivity to transfer electrons or they may form protective or destructive scales. The methods and compositions described herein are expected to be useful in these environments susceptible to scale formation. These species are present as a consequence of the dissolution of the oil and gas subsurface geological formation or by consuming electrons from steel pipe via iron oxidation process or by the reaction of gases with the constituents in the aqueous solution. These species range in concentration from about 10 ppm independently to about 300,000 ppm based on the total volume of the fluid, alternatively from about 100 ppm independently to about 10,000 ppm, or from about 500 ppm independently to about 5,000 ppm.

The salt species may have or include, but are not limited to, metal carbonates, metal sulfates, metal oxides, metal phosphates, metal sulfides and combinations thereof. The retention of the respective salt constituents in ionic form, i.e. the solubility, depends upon such factors as water temperature, pH, ion concentration, and the like. The metal of the corrosion causing components may be or include, but is not limited to calcium, magnesium, barium, iron, zinc, and combinations thereof.

The corrosion inhibitor additive may be introduced into the environment to which the corrodible material will be, or is being, exposed. Such environment, which includes some proportion of water, may be, in certain non-limiting embodiments, a brine, a hydrocarbon producing system such as a crude oil or a fraction thereof, or a wet hydrocarbon containing gas, such as may be obtained from an oil and/or gas well. The corrosion inhibitor may be, prior to incorporation into or with a given corrosive environment in liquid form.

Incorporation of the corrosion inhibitor additive into the corrosive and high temperature environment may be by any means known to be effective by those skilled in the art. Simple dumping, such as into a drilling mud pit; addition via tubing in a suitable carrier fluid, such as water or an organic solvent; injection; or any other convenient means may be adaptable to these compositions. Large scale environments such as those that may be encountered in oil production, combined with a relatively turbulent environment, may not require additional measures, after or during, to ensure complete dissolution or dispersal of the corrosion inhibiting composition. In contrast, smaller, less turbulent environments, such as relatively stagnant settling tanks, may benefit from mechanical agitation of some type to optimize the performance of the corrosion inhibiting additive; however, such mechanical agitation is not required. Those skilled in the art would be readily able to determine appropriate means and methods in this respect.

In a non-limiting embodiment, a downhole fluid may be injected into the bottom of a well at a time selected from the group consisting of: prior to incorporating the corrosion inhibitor additive, after the incorporating the corrosion inhibitor additive, at the same time as incorporating the corrosion inhibitor additive, and combinations thereof. The downhole fluid may be or include, but is not limited to, a downhole fluid selected from the group consisting of drilling fluids, completion fluids, stimulation fluids, packer fluids, injection fluids, servicing fluids, and combinations thereof.

The corrosion inhibitor additive may contact a metal surface for decreasing, reducing, or inhibiting the corrosion of the metal surface. The metal surface may be or include, but is not limited to, a ferrous metal surface, a non-ferrous surface, alloys thereof, and combinations thereof. In certain non-limiting embodiments, examples of the metal within the metal surfaces may have or include, but not be limited to, commonly used structure metals such as aluminum; transition metals such as iron, zinc, nickel, and copper; steel; alloys thereof; and combinations thereof. In a non-limiting embodiment, the metal surface may be painted and/or coated.

In one non-limiting embodiment the metal surface is low alloy carbon steel and the corrosive environment in contact with the low alloy carbon steel contains carbon dioxide (CO₂). As defined herein, “low alloy” carbon steel is defined as containing about 0.05% sulfur and melts around 1,426 to 1,538° C. (2,599-2,800° F.). A non-limiting example of low alloy carbon steel is A36 grade. Suitable low alloy carbon steels include, but are not necessarily limited to, API tubing steel grades such as H40, J55, K55, M65, N80.1, N80.Q, L80.1, C90.1, R95, T95, C110, P110, Q125.1. Pipeline steels that are also of particular interest include, but are not necessarily limited to, X65 and X70. The designation includes seamless proprietary grades with similar compositions.

The corrosion inhibitor additive may suppress, inhibit, or decrease the amount of and/or the rate of corrosion of the metal surface within the oil and gas carbon steel piping. That is, it is not necessary for corrosion of the metal surface to be entirely prevented for the methods and compositions discussed herein to be considered effective, although complete prevention is a desirable goal. Success is obtained if less corrosion occurs in the presence of the corrosion inhibitor additive than in the absence of the corrosion inhibitor additive. Alternatively, the methods described are considered successful if there is at least a 30% decrease in corrosion of the metal surfaces within the subterranean formation. Additionally, the methods described herein are applicable where the predominant corrosion process is the dissolution of iron to Fe²⁺. “Predominant” is defined as where at least 50 area % of the corrosion that occurs is due to the dissolution of iron to Fe²⁺. These traditionally occur in systems where the oxygen content is low and redox potential is in the range from 0 to −0.7 Volts with respect to the hydrogen electrode.

Performance of a given corrosion inhibitor additive may be tested using any of a variety of methods, such as those specified by the American Society for Testing Materials (ASTM) or NACE International (NACE). One effective method to test the performance of a corrosion inhibitor additive under conditions of moderate shear, involves a rotating coupon electrochemical technique described in ASTM: Standard Guide for Evaluating and Qualifying Oilfield and Refinery Corrosion Inhibitors in the Laboratory (Designation ASTM G170-01a), and also in NACE Publication 5A195, Item No. 24187, “State of the Art Report on Controlled-Flow Laboratory Corrosion Tests.” In this test, various concentrations of inhibitor chemistries are introduced into a given perspective corrosive environment. The coupons are then rotated at high speed in the environment to generate moderate shear stress on the metal surfaces. Electrochemical techniques, such as, for example, linear polarization resistance (LPR), are then employed under these moderate shear conditions, to monitor the prevailing general corrosion rate as well as to identify instances of localized corrosion. A concentration profile is then generated to establish the minimum effective concentration of the corrosion inhibitor additive that is required to adequately protect the coupon at an acceptable corrosion rate.

The invention will now be described with respect to certain specific examples which are simply meant as non-limiting illustrations thereof and not necessarily limiting of the invention.

### EXAMPLES

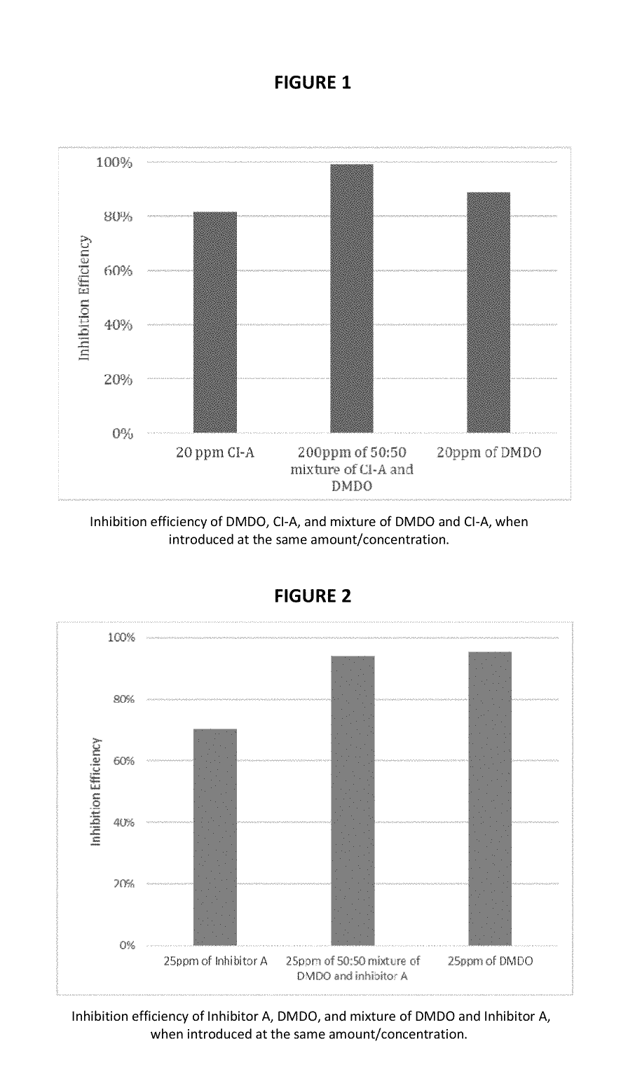

FIG. 1 shows the corrosion inhibition performance of DMDO at 20 ppm, CI-A, an oleic imidazoline corrosion inhibitor, at 20 ppm, and an additive comprising equal part of DMDO and CI-A at 20 ppm.

As shown, the efficiency of 20 ppm of the combination of the DMDO and CI-A is better than the average efficiency (˜85%) of CI-A and DMDO, each at 20 ppm, indicating the synergistic impact of using the two-component corrosion inhibitor additive disclosed herein. As a result of this synergistic performance, a lower amount of the corrosion inhibitor additive may be used to achieve the same or better results in reducing, decreasing, or inhibiting the corrosion of the metal surface as compared to an otherwise identical method for reducing corrosion absent the use of the corrosion inhibitor additive disclosed herein.

A similar synergistic effect is seen when combining certain other scale inhibitor compounds or corrosion inhibitor compounds with DMDO.

In FIG. 2, the efficiency of 25 ppm of Inhibitor A, a polyether amine phosphonate scale inhibitor, 25 ppm DMDO, and 25 ppm of a 50:50 mixture of DMDO and Inhibitor A is shown.

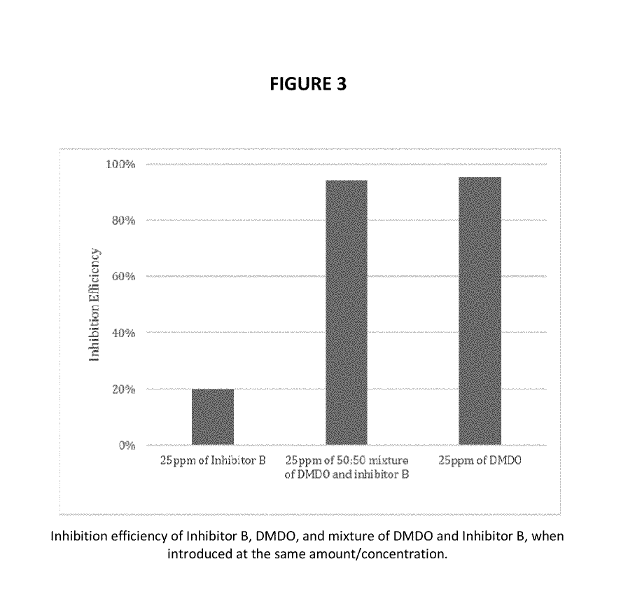

In FIG. 3, the efficiency of 25 ppm of Inhibitor B, a polycarboxylic acid corrosion inhibitor, 25 ppm DMDO, and 25 ppm of a 50:50 mixture of DMDO and Inhibitor B is shown.

In both FIG. 2 and FIG. 3, the efficiency of the 50:50 mixture of DMDO and Inhibitor A or B is better than the average efficiency of the DMDO and inhibitor A or B.

In the foregoing specification, the invention has been described with reference to specific embodiments thereof, and has been described as effective in providing methods for decreasing, reducing, or inhibiting corrosion of a metal surface in a high temperature environment. However, it will be evident that various modifications and changes can be made thereto without departing from the broader scope of the invention as set forth in the appended claims. Accordingly, the specification is to be regarded in an illustrative rather than a restrictive sense. For example, specific first components, second components, downhole fluids, and corrosion forming components falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method for decreasing, reducing, or inhibiting corrosion of a metal surface in a high temperature environment where less corrosion of the metal surface occurs as compared to an otherwise identical method absent the corrosion inhibitor additive, or alternatively as compared to a method using only the first component or only the second component at the same total dosage, may consist of or consist essentially of incorporating a corrosion inhibitor additive into a corrosive environment within a subterranean formation to inhibit corrosion of the metal surface; the corrosion inhibitor additive may comprise, consist essentially of, or consist of, a first component and a second component; where the first component has the following Formula (A):

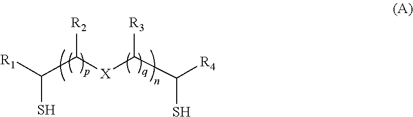

wherein x is oxygen or hydrogenated nitrogen or quaternized nitrogen; R1, R2, R3 and R4 are independently hydrogen, methyl or an alkyl group; p, q and n could be integers from 1 to 100; and the second component may be one or more of the following: 1) imidazolines and amides, such as the reaction products of fatty acids and amines (di-amines, tri-amines, or di-amines and tri-amines that are alcohol or thiol substituted), 2) quaternary amines, such as bis-quaternary amines, 3) carboxylic acid reaction products including maleic derivatives reacted with unsaturated alkyl carboxylic acids, and dimerized or trimerized acids including unsaturated alkyl groups, 4) organophosphates, especially ethoxylated organophosphate esters, 5) phenathradine derivatives and 6) heterocyclic molecules containing one or both of nitrogen and sulfur, or 7) combinations thereof.

The method may also comprise, consist of or consist essentially of incorporating a corrosion inhibitor additive into a corrosive environment within a subterranean formation to inhibit corrosion of the metal surface; the corrosion inhibitor additive comprising, consisting of, or consisting essentially of a first component represented by Formula (A1):

SH—CH₂—[CH₂—O—CH₂]_{z}—CH₂—SH (A1)

wherein z is an integer ranging from 1 to 100 and a second component the corrosion inhibitor additive may include a second component selected from the group consisting of 1) imidazolines and amides, such as the reaction products of fatty acids and amines (di-amines, tri-amines, or di-amines and tri-amines that are alcohol or thiol substituted), 2) quaternary amines, such as bis-quaternary amines, 3) carboxylic acid reaction products including maleic derivatives reacted with unsaturated alkyl carboxylic acids, and dimerized or trimerized acids including unsaturated alkyl groups, 4) organophosphates, especially ethoxylated organophosphate esters, 5) phenathradine derivatives and 6) heterocyclic molecules containing one or both of nitrogen and sulfur, and 7) combinations thereof.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for inhibiting corrosion of a metal surface in a corrosive environment, where the method comprises:
bringing a corrosion inhibitor additive into contact with the metal surface in the corrosive environment to at least partially inhibit corrosion of the metal surface; where the corrosion inhibitor additive comprises a first component having the formula (A): 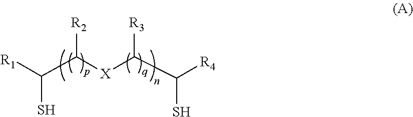
wherein x is oxygen or hydrogenated nitrogen or quaternized nitrogen; R₁, R₂, R₃ and R₄ are independently hydrogen, methyl or an alkyl group; n, p, and q are independently integers from 1 to 100; and
a second component selected from the group consisting of imidazolines, amides, quaternary amines, carboxylic acid reaction products, organophosphates, phenathradine derivatives, heterocyclic molecules containing one or both of nitrogen and sulfur, and combinations thereof.
where a lower amount of the corrosion inhibitor additive is used to achieve the same or better results in inhibiting the corrosion of the metal surface as compared to an otherwise identical method absent the corrosion inhibitor additive.

2. The method of claim 1 wherein the first component is represented by Formula (A1):
SH—CH₂—[CH₂—O—CH₂]_{z}—CH₂—SH (A1)
wherein z is an integer ranging from 1 to 100.

3. The method of claim 1 wherein the second component is selected from the reaction products of fatty acids and amines, bis-quaternary amines, maleic derivatives reacted with unsaturated alkyl carboxylic acids or dimerized or trimerized acids including unsaturated alkyl groups, ethoxylated organophosphate esters, phenathradine derivatives, heterocyclic molecules containing one or both of nitrogen and sulfur, and combinations thereof.

4. The method of claim 1, where the corrosive environment is at a temperature ranging from about 100° F. (38° C.) to about 500° F. (260° C.), and where the corrosion inhibitor additive is stable.

5. The method of claim 1, where the effective amount of the corrosion inhibitor additive ranges from about 0.01 ppm to about 1,000 ppm based on the total amount of fluid in the corrosive environment.

6. The method of claim 1, where the molar ratio of the first component to the second component of the corrosion inhibitor additive ranges from about 1:100 to about 100:1.

7. The method of claim 1, where the corrosive environment is a downhole fluid, and the method further comprises circulating the downhole fluid into a subterranean formation; where the circulating the downhole fluid occurs at a time selected from the group consisting of: prior to incorporating the corrosion inhibitor additive, after the incorporating the corrosion inhibitor additive, at the same time as incorporating the corrosion inhibitor additive, and combinations thereof, where the downhole fluid is selected from the group consisting of drilling fluids, completion fluids, stimulation fluids, packer fluids, injection fluids, servicing fluids, and combinations thereof.

8. The method of claim 7, where the subterranean formation is part of an offshore well.

9. The method of claim 1, where the metal surface is selected from the group consisting of a pipe, a wellhead, and combinations thereof.

10. A method for inhibiting corrosion of a metal surface in a corrosive environment at a temperature ranging from about 100° F. (38° C.) to about 500° F. (260° C.), where the method comprises:
circulating a fluid in the corrosive environment, where the fluid is selected from the group consisting of drilling fluids, completion fluids, stimulation fluids, packer fluids, injection fluids, servicing fluids, and combinations thereof; and
incorporating a corrosion inhibitor additive into the fluid in an amount ranging from about 0.1 ppm to about 1,000 ppm based on the total amount of the fluid in the corrosive environment to inhibit corrosion of the metal surface; where the corrosion inhibitor additive comprises a first component and a second component; where the circulating the fluid occurs at a time selected from the group consisting of: prior to incorporating the corrosion inhibitor additive, after the incorporating the corrosion inhibitor additive, at the same time as incorporating the corrosion inhibitor additive, and combinations thereof;
where the first component has the formula (A): 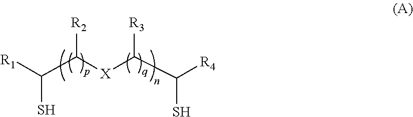
wherein x is oxygen or hydrogenated nitrogen or quaternized nitrogen; R₁, R₂, R₃ and R₄ are independently hydrogen, methyl or an alkyl group; n, p and q are independently integers from 1 to 100;
where the second component is selected from the group consisting of imidazolines, quaternary amines, carboxylic acid reaction products, organophosphates, and combinations thereof;
where the corrosion inhibitor additive is stable, and where a lower amount of the corrosion inhibitor additive is used to achieve the same or better results in inhibiting the corrosion of the metal surface as compared to an otherwise identical method using only the first component or only the second component at the same total dosage.

11. A method for inhibiting corrosion of a metal surface in contact with a corrosive environment, where the method comprises:
incorporating an anti-corrosive additive into the corrosive environment to inhibit corrosion of the metal surface; where the anti-corrosive additive comprises a first component represented by Formula (A1):
SH—CH₂—[CH₂—O—CH₂]_{z}—CH₂—SH (A1)
where z is 2; and
a second component selected from the group consisting of imidazolines, quaternary amines, organophosphates, and combinations thereof; and where a lower amount of the anti-corrosive additive is used to achieve the same or better results in inhibiting the corrosion of the metal surface as compared to an otherwise identical method absent the anti-corrosive additive.

12. The method of claim 11, where the amount of the anti-corrosive additive ranges from about 0.1 ppm to about 10,000 ppm based on the total amount of the corrosive environment.

13. The method of claim 11, where the molar ratio of the first component to the second component of the anti-corrosive additive ranges from about 1:100 to about 100:1.

14. The method of claim 11, where the anti-corrosive additive is stable at a temperature ranging from about 200° F. (92° C.) to about 500° F. (260° C.).

15. The method of claim 11, where the corrosive environment is a downhole fluid and the method further comprises circulating the downhole fluid into a subterranean formation; where the circulating the downhole fluid occurs at a time selected from the group consisting of: prior to incorporating the anti-corrosive additive, after the incorporating the anti-corrosive additive, at the same time as incorporating the anti-corrosive additive, and combinations thereof, where the downhole fluid is selected from the group consisting of drilling fluids, completion fluids, stimulation fluids, packer fluids, injection fluids, servicing fluids, and combinations thereof.

16. The method of claim 15, where a temperature of the downhole fluid ranges from about 150° F. (72° C.) to about 500° F. (260° C.).

17. The method of claim 11 where the carbon dioxide is present in the corrosive environment and the metal surface is a low alloy carbon steel.

18. The method of claim 17 when the corrosive environment comprises a packer fluid.

19. The method of claim 17 when the corrosive environment comprises a pipeline or refinery where the corrosive environment comprises a liquid and gaseous environment and a predominant corrosion process is the dissolution of iron to Fe²⁺.
